(19) United States
(12) Patent Application Publication
(10) Pub. No.: US 2012/0299801 A1
(43) Pub. Date: Nov. 29, 2012

(54) LIGHT SOURCE DEVICE AND IMAGE DISPLAY APPARATUS

(75) Inventor: Hiroshi KITANO, Hyogo (JP)

(73) Assignee: PANASONIC CORPORATION, Osaka (JP)

(21) Appl. No.: 13/477,844

(22) Filed: May 22, 2012

(30) Foreign Application Priority Data
May 23, 2011 (JP) 2011-115185

(51) Int. Cl. G09G 3/00; F21V 29/00

(52) U.S. Cl. 345/32; 362/249.02

(57) ABSTRACT

A light source device 100 includes: multiple semiconductor laser light sources 101; a base plate 102 having thereon an installation area on which the multiple semiconductor laser light sources 101 are installed and which is divided into multiple areas, thus dividing the multiple semiconductor laser light sources 101 on the installation area into the multiple groups such that each of the groups includes one of the multiple semiconductor laser light sources 101 or at least two of the semiconductor laser light sources 101 that are electrically connected in series; and a current control section 109 configured to conduct temperature control of the semiconductor laser light sources 101 by independently controlling a value of current flowing in each of the groups of the multiple semiconductor laser light sources 101 on the installation area.

### BACKGROUND OF THE INVENTION

1. Field of the Invention

The present invention relates to a light source device, and an image display apparatus including the light source device.

2. Description of the Background Art

Hitherto, for example, there are cases where a solid light source such as a semiconductor laser light source and the like is used in an image display apparatus such as a projector and the like. In such cases, when a state of the light source being at a high temperature continues for a long period of time, a problem arises where an optical output of the light source deteriorates. In order to avoid such a problem, typically, a cooling device such as a heat sink and the like and a cooling fan and the like are used for cooling. As a result, a state of the semiconductor laser light source being at a high temperature, and a state of exposing, to a high temperature, a base plate on which the light source is disposed, are prevented from continuing for a long period of time.

However, multiple light sources are densely arranged in the light source device used in the image display apparatus such as the projector and the like. Therefore, with the above described cooling method, the densely arranged light sources cannot be uniformly cooled, and unevenness in cooling occurs. When such unevenness in cooling occurs and some of the light sources are insufficiently cooled, those light sources cannot output light having a stable intensity when compared to the rest of the light sources, and thereby a lifespan thereof becomes short. As a result, variation in lifespan occurs among the multiple light sources, and the lifespan of the light source device itself also becomes short due to the variation.

Japanese Laid-Open Patent Publication No. 2009-31622 discloses an image projection device that predicts a temperature increase in the vicinity of a light source, and conducts light control for suppressing the amount of heat generated by the light source. With such an image projection device, the temperature within a unit can be maintained at a temperature acceptable for components mounted around the light source.

### SUMMARY OF THE INVENTION

However, cooling unevenness that occurs among multiple light sources cannot be solved by the image projection device disclosed in Japanese Laid-Open Patent Publication No. 2009-31622. Thus, the problem regarding reduced lifespan of the light source device caused by the variation in lifespan among the multiple light sources cannot be solved.

The present invention has been made in view of such a conventional problem, and an objective of the present invention is to provide a light source device that is highly reliable due to having an extended lifespan as a result of a reduction in variation of lifespan among multiple semiconductor laser light sources, and an image display apparatus including the light source device.

A light source device of the present invention includes: multiple semiconductor laser light sources; a base plate having thereon an installation area on which the multiple semiconductor laser light sources are installed and which is divided into multiple areas, thus dividing the multiple semiconductor laser light sources on the installation area into multiple groups such that each of the groups includes one of the multiple semiconductor laser light sources or at least two of the semiconductor laser light sources that are electrically connected in series; and a current control unit configured to conduct temperature control of the semiconductor laser light sources by independently controlling a value of current flowing in each of the groups of the multiple semiconductor laser light sources on the installation area.

In the present invention, a value of current flowing in each of the groups of the semiconductor laser light sources is independently controlled. For example, a current value can be selectively lowered for a group of semiconductor laser light sources located at a position that is relatively difficult to cool among the multiple groups; or a current value can be selectively increased for a group of semiconductor laser light sources located at a position that is relatively easy to cool among the multiple groups. As a result, variation of lifespan of the semiconductor laser light sources among the multiple groups can be prevented, and thereby lifespan of the light source device is not reduced and an optimal optical output can be sustained.

For example the current control unit may conduct the temperature control such that a value of current flowing in a group of semiconductor laser light sources becomes smaller as temperature of the semiconductor laser light sources in the group becomes higher, in a case where conditions of the current flowing in the semiconductor laser light sources are identical among the multiple groups. Furthermore, for example the current control unit may conduct the temperature control such that a value of current flowing in a group of semiconductor laser light sources becomes larger as temperature of the semiconductor laser light sources in the group becomes lower, in a case where conditions of the current flowing in the semiconductor laser light sources are identical among the multiple groups. Furthermore, for example, the light source device may further include a cooling unit configured to cool the multiple semiconductor laser light sources by causing fluid that absorbs heat released from the multiple semiconductor laser light sources to flow. Then, the current control unit may conduct the temperature control such that a value of current flowing in a group of semiconductor laser light sources becomes larger for a group including semiconductor laser light sources that are cooled at more upstream of a circulation route of the fluid of the cooling unit.

With the present invention, by having the above described configuration, the semiconductor laser light sources can be maintained within an optimum temperature range, it is possible to suppress an increase in the temperature of the semiconductor laser light sources, and increase cooling efficiency. As a result, variation of lifespan of the semiconductor laser light sources among the multiple groups can be reduced, and extension of lifespan of the light source device can be promoted.

For example, the light source device may further include a current ratio calculating unit configured to calculate, as a current ratio, a ratio of a value of current flowing in one group of the semiconductor laser light sources among the multiple groups with regard to a value of current flowing in another group of the semiconductor laser light sources.

With the present invention, by having the above described configuration, current flowing in each of the multiple groups can be controlled based on the obtained current ratio. Thus, temperature of the semiconductor laser light sources can be regulated more accurately.

For example, the current control unit may conduct the temperature control based on a result of comparing temperatures of the semiconductor laser light sources among the multiple groups.

For example, the light source device may select a lighting mode that is to be used among multiple lighting modes; and the current control unit may conduct the temperature control in accordance with the selected lighting mode.

With the present invention, by having the above described configuration, temperature of the semiconductor laser light sources can be regulated while using a display-condition desired by a user.

For example, the current control unit may conduct the temperature control in accordance with a lighting time period of the semiconductor laser light source.

With the present invention, by having the above described configuration, temperature of the semiconductor laser light sources can be regulated accurately in a temporal manner.

In one example, the light source device includes a plurality of the base plates, wherein: the plurality of the base plates are thermally isolated from each other; the multiple semiconductor laser light sources are divided and arranged on the plurality of the base plates; and the semiconductor laser light sources arranged on each of the base plates form a single group or are divided into multiple groups.

With the present invention, by having the above described configuration, the size of each of the base plates can be reduced, and the degree of integration of each component in the light source device can be increased. Furthermore, since the plurality of base plates are thermally isolated from each other, cooling efficiency becomes better and temperature control can be conducted easily when compared to arranging a large number of semiconductor laser light sources on a single base plate.

For example, the light source device may further include an optical component configured to condense light irradiated from the multiple semiconductor laser light sources, and the optical component may be arranged so as to condense the light irradiated from the multiple semiconductor laser light sources onto a single area.

With the present invention, by having the above described configuration, irradiated light obtained from the multiple light sources can be condensed, and a high intensity colored light can be obtained.

For example, the light source device may further include a frequency conversion material configured to convert wavelength of the light irradiated from the multiple semiconductor laser light sources, and the frequency conversion material may be disposed on the area where the light condensed by the optical component is irradiated.

With the present invention, by having the above described configuration and using a fluorescent substance as the frequency conversion material, desired fluorescent light with high intensity can be obtained. Furthermore, by having multiple frequency conversion materials, light with various colors can be obtained using, as excitation light, light irradiated from semiconductor laser light sources having the same wavelength.

For example, the light source device may further include a cooling unit that is thermally connected to the base plate.

With the present invention, by having the above described configuration, cooling efficiency of the semiconductor laser light sources can be further increased. As a result, variation of lifespan can be reduced among the multiple semiconductor laser light sources, and extension of lifespan of the light source device can be promoted. By conducting the temperature control while having the cooling unit conduct the cooling, a large current value can be applied as compared to not using the cooling unit. Thus, a high optical output can be obtained while preventing variation of lifespan among the multiple semiconductor laser light sources and reduction in lifespan of the light source device.

For example, the wavelengths emitted from the multiple semiconductor laser light sources may be identical.

With the present invention, by having the above described configuration, it is possible to limit the type of the semiconductor laser light sources. As a result, cost can be reduced, and each of the semiconductor laser light sources can be driven easily. When the above described configuration is employed, the multiple semiconductor laser light sources that emit an identical wavelength are divided into multiple groups, and temperature of the semiconductor laser light sources is independently controlled in each of the groups.

Furthermore, a light source device of the present invention includes: multiple semiconductor laser light sources; and a base plate having thereon an installation area on which the multiple semiconductor laser light sources are installed and which is divided into multiple areas, thus dividing the multiple semiconductor laser light sources on the installation area into multiple groups. Here, temperature control of the semiconductor laser light sources is conducted by providing, on the base plate, areas in which installation densities of the semiconductor laser light sources are different from each other.

With the present invention, by having the above described configuration, the number of semiconductor laser light sources arranged per unit area can be reduced for a group including semiconductor laser light sources located at a position that is relatively difficult to cool among the multiple groups, and thereby it is possible to suppress an increase in the temperature of the semiconductor laser light sources, and increase cooling efficiency. On the other hand, the number of semiconductor laser light sources arranged per unit area can be increased for a group including semiconductor laser light sources located at a position that is relatively easy to cool among the multiple groups, and thereby a sufficient optical output can be ensured while preventing a reduction in lifespan of the semiconductor laser light sources. As a result, variation of lifespan among the multiple semiconductor laser light sources can be reduced, extension of lifespan of the light source device can be promoted, and the semiconductor laser light sources can sustain, as a whole, a high optical output.

Furthermore, an image display apparatus of the present invention includes: the light source device; a condensing lens configured to condense light irradiated from the light source device; a frequency conversion unit including a frequency conversion material configured to convert wavelength of the irradiated light condensed by the condensing lens; a light guiding unit configured to guide luminous fluxes of the irradiated light whose wavelengths are converted by the frequency conversion unit; an image display element configured to modulate the irradiated light guided by the light guiding unit, in accordance with an image signal; and a projection lens configured to project, onto a screen, the irradiated light modulated by the image display element.

By having the above described configuration, the present invention can provide an image display apparatus including the light source device that is highly reliable due to having a small variation of lifespan among the multiple semiconductor laser light sources and allowing extension of lifespan.

With the present invention, variation of lifespan among the multiple semiconductor laser light sources can be reduced, and lifespan of the light source device can be extended. Thus, a highly reliable light source device, and an image display apparatus including the light source device can be provided.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1A is a front view of a light source device according to one aspect of the embodiments of the present invention (first embodiment);

FIG. 1B is a side view of the light source device according to one aspect of the embodiments of the present invention (first embodiment);

FIG. 2 is an illustrative diagram of semiconductor laser light sources according to one aspect of the embodiments of the present invention (first embodiment);

FIG. 3 is an illustrative diagram of a base plate according to one aspect of the embodiments of the present invention (first embodiment);

FIG. 4 is an illustrative diagram of a light source device according to one aspect of the embodiments of the present invention (second embodiment);

FIG. 5 is an illustrative diagram of a light source device according to one aspect of the embodiments of the present invention (third embodiment);

FIG. 6 is an explanatory illustrative diagram of an image display apparatus according to one aspect of the embodiments of the present invention (fourth embodiment);

FIG. 7 is an illustrative diagram of a frequency conversion unit according to one aspect of the embodiments of the present invention (fourth embodiment); and

FIG. 8 is an illustrative diagram of the image display apparatus according to one aspect of the embodiments of the present invention (fourth embodiment).

### DESCRIPTION OF THE PREFERRED EMBODIMENTS

### First Embodiment

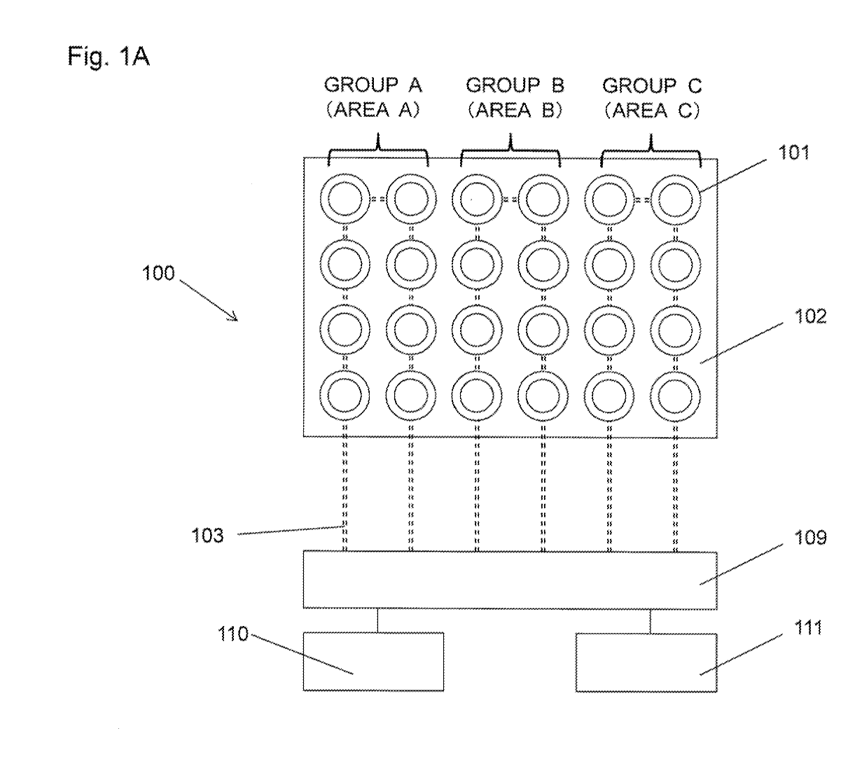

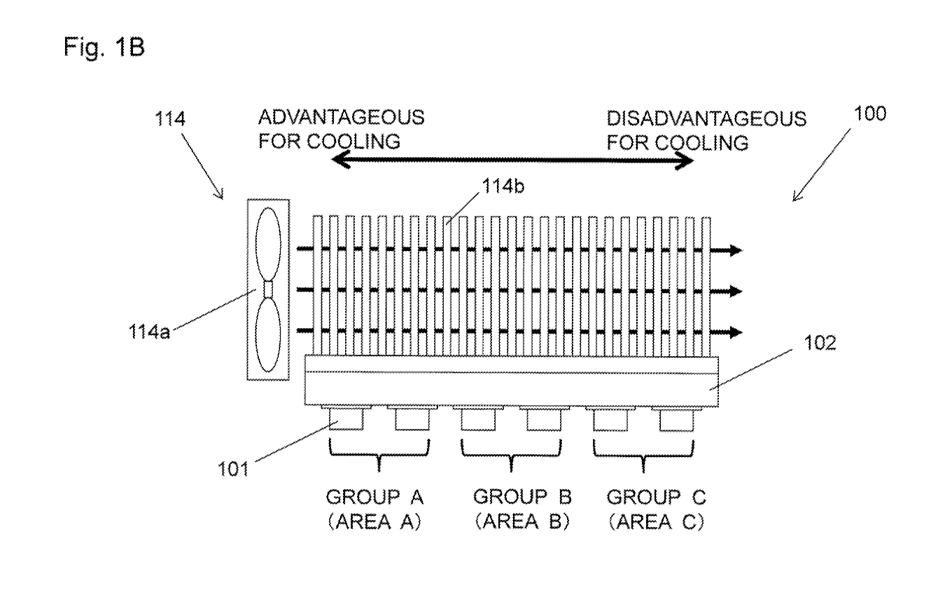

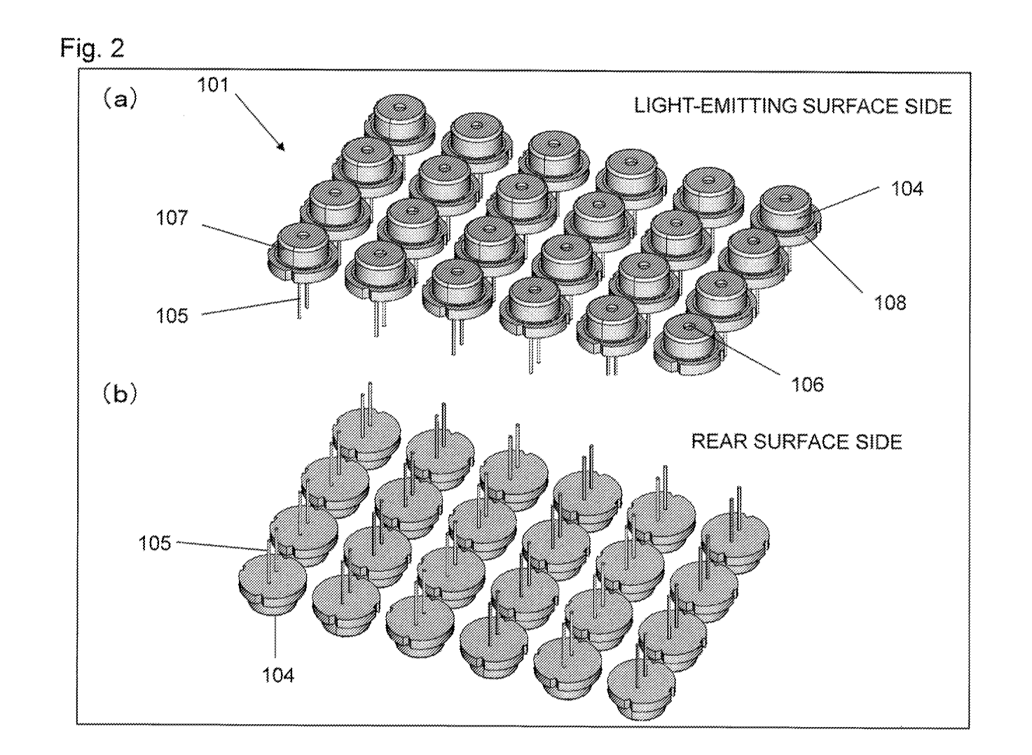

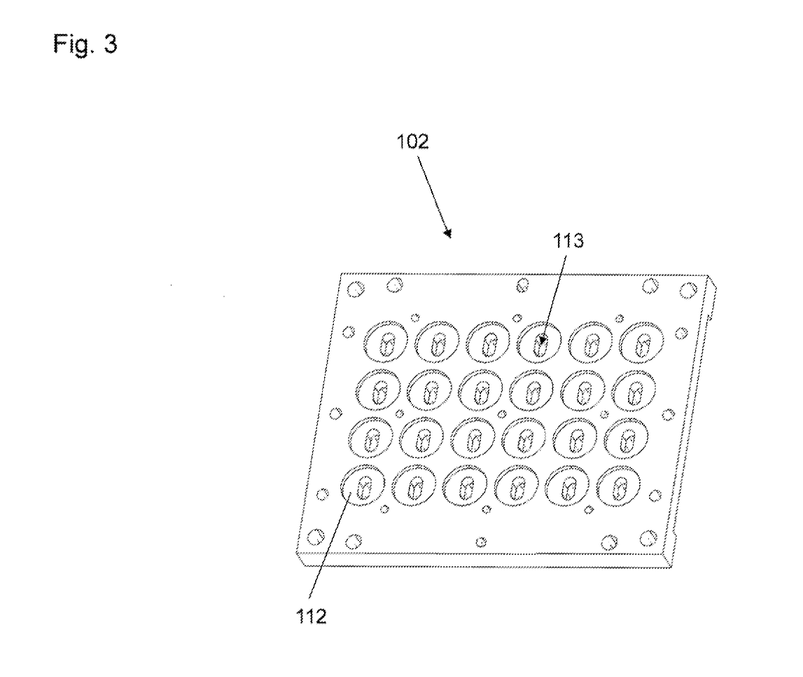

In the following, a light source device of the present embodiment will be described with reference to the drawings. FIG. 1A is a front view of a light source device 100 according to the present embodiment. FIG. 1B is a side view of the light source device 100 according to the present embodiment. FIG. 2 is an illustrative diagram of semiconductor laser light sources 101 according to the present embodiment; and FIG. 2(a) is an illustrative diagram of a light-emitting surface side of the semiconductor laser light sources 101, and FIG. 2(b) is an illustrative diagram of a rear surface side thereof. FIG. 3 is an illustrative diagram of a base plate 102 according to the present embodiment.

As shown in FIG. 1A, the light source device 100 according to the present embodiment includes: the multiple semiconductor laser light sources 101; the base plate 102 having thereon an installation area on which the multiple semiconductor laser light sources 101 are installed and which is divided into multiple areas, thus dividing the semiconductor laser light sources 101 into multiple groups such that each of groups includes one of the multiple semiconductor laser light sources 101 or at least two of the semiconductor laser light sources 101 that are electrically connected in series; and a current control section (current control unit) 109 configured to conduct temperature control of the semiconductor laser light sources 101 by independently controlling a value of current flowing in each of the groups of the multiple semiconductor laser light sources 101 on the installation area. In the following, descriptions are provided for each component and an arrangement thereof.

<Regarding Semiconductor Laser Light Sources>

Description will be provided for the semiconductor laser light sources 101. For a purpose of obtaining light with a desired color for the light source device 100 according to the present embodiment, the semiconductor laser light sources 101 are light sources configured to irradiate light which becomes a source of the light having the desired color. There is no particular limitation in the type of the semiconductor laser light sources 101. For example, when semiconductor laser light sources configured to irradiate ultraviolet light and semiconductor laser light sources configured to irradiate blue light are used as the semiconductor laser light sources 101; a mechanism of obtaining red fluorescent light and green fluorescent light can be used when the irradiated light is used as excitation light. Using this mechanism is preferable, since the three primary colors can be obtained and light with various colors can be obtained by combining the three primary colors. In the present embodiment, a group is formed by the multiple semiconductor laser light sources 101 that are configured to emit light with an identical wavelength and that are electrically connected in series by a wiring base material 103. In addition, a plurality of such groups are formed on the same base plate 102. Thus, the multiple semiconductor laser light sources 101 are divided into multiple groups. Each of the groups of the semiconductor laser light sources 101 is arranged at one of the multiple areas provided on the base plate 102. With this, it becomes possible to independently conduct the temperature control in each of the groups.

As shown in FIG. 2(a) and FIG. 2(b), each the semiconductor laser light sources 101 includes a main body part 104, and a leg part 105 consisting of multiple lead electrodes (in the present embodiment, shown as an example is a case in which the number of lead electrodes is two). A laser emitting section 106 configured to emit laser light is provided on the main body part 104. The main body part 104 includes a bulged part 107 on which the laser emitting section 106 is located at a center thereof, and a rim part 108 provided on the periphery of the bulged part 107.

The leg part 105 includes a lead electrode that becomes an anode and a lead electrode that becomes a cathode. When the multiple semiconductor laser light sources 101 are aligned in a single line or arranged in a matrix, the lead electrodes are arranged such an anode of one of the semiconductor laser light sources 101 is arranged next to a cathode of an adjacent semiconductor laser light source 101. By using such an arrangement, the multiple semiconductor laser light sources 101 in each of the groups become electrically connected in series when the lead electrodes of each of the semiconductor laser light sources 101 are connected by the wiring base material 103 which is described later.

There is no particular limitation in the method for conducting the temperature control of a group of the semiconductor laser light sources 101. For example, for a group of the semiconductor laser light sources 101 arranged at a position where the temperature becomes relatively high when the same current value is applied to all the groups, a method of selectively lowering the current value for that group, or a method of reducing the number of the semiconductor laser light sources 101 arranged per unit area for that group may be used. Shown as an example in the present embodiment is a method of having the same number of the semiconductor laser light sources 101 belonging to each of the groups, and adjusting a value of current supplied to each of the groups. The number of the semiconductor laser light sources 101 arranged per unit area, i.e., installation density, is identical in all the groups.

There is no particular limitation in the method for adjusting the value of current supplied to each of the groups. For example, a method of having the current control section (current control unit) 109 configured to independently control each value of current flowing in the multiple groups may be used. In such a case, for example, the light source device 100 includes a temperature detection section configured to directly or indirectly measure the temperature of the semiconductor laser light sources 101 in each of the groups. The temperature detection section detects temperature information of the semiconductor laser light sources 101 in each of the groups by using a temperature sensor or the like attached to the semiconductor laser light sources 101 or the base plate 102. The current control section 109 acquires the temperature information of the semiconductor laser light sources 101 in each of the groups when the current control section 109 receives an input of the value detected by the temperature detection section. Furthermore, when conditions of the current flowing in the semiconductor laser light sources 101 are identical among the multiple groups (e.g., when the current values are identical), the current control section 109 conducts the temperature control of the semiconductor laser light sources 101 such that a value of current flowing in a group is reduced for a group of the semiconductor laser light sources 101 that becomes a higher temperature among the multiple groups, and such that a value of current flowing in a group is increased for a group of the semiconductor laser light sources 101 that becomes a lower temperature among the multiple groups. To conduct the temperature control, the current control section 109 compares the temperature information obtained by using the temperature sensor or the like of the temperature detection section with data (reference temperature) that is pre-stored in a ROM, accesses data (control value) in the ROM depending on the comparison result, and sets a value of current to be supplied to each of the groups of the semiconductor laser light sources 101. For example, when the temperature of the semiconductor laser light sources 101 inputted by the temperature detection section is higher than the reference temperature, the current control section 109 sets a current value of a group including those semiconductor laser light sources 101 to the control value that is lower than a standard value. On the other hand, when the temperature of the semiconductor laser light sources 101 inputted by the temperature detection section is lower than the reference temperature, the current control section 109 sets a current value of a group including those semiconductor laser light sources 101 to the control value that is larger than the standard value.

Furthermore, the light source device 100 may further include a current ratio calculation section (current ratio calculating unit) 110 configured to calculate, as a current ratio, a ratio of a value of current flowing in one group with regard to a value of current flowing in another group. In such a case, the current control section 109 may change the current ratio based on a result of comparing temperatures of the semiconductor laser light sources 101 among the multiple groups. For example, the current control section 109 measures temperature of the semiconductor laser light sources 101 belonging to a certain group during the course of time, or measures all the temperatures of the semiconductor laser light sources 101 belonging to a certain group and calculates an average value thereof. As a result, temperature information which is used as the temperature representing the group is acquired. By the same method, temperature information which is used as the temperature representing other groups is also acquired. Then, the current control section 109 compares the temperature information among groups, and adjusts the current ratio so as to reduce a value of current flowing in a group whose temperature is relatively high.

Furthermore, the light source device 100 may further include a lighting mode storing section (lighting mode storing unit) 111 having pre-stored therein a lighting mode (e.g., high brightness mode, normal mode, power saving mode, etc.) set at the time of product-shipment, or set in accordance with a lighting mode uniquely set by a user after product-shipment. In such a case, the current control section 109 may change the current ratio in accordance with a lighting mode (lighting mode that is to be used) preset in the lighting mode storing section 111. For example, the current control section 109 changes the current ratio so as to reduce a value of current flowing each group for a lighting mode whose consumption of power is large. Furthermore, the current control section 109 may change the current ratio in accordance with a lighting time period of the semiconductor laser light sources 101. For example, the current control section 109 may change the current ratio so as to reduce a value of current flowing in each of the groups as the lighting time period (e.g., continuous lighting time period) of the semiconductor laser light sources 101 becomes prolonged.

Area A, area B, and area C are formed on the base plate 102 as shown in FIG. 1A and FIG. 1B. The multiple semiconductor laser light sources 101 disposed on the base plate 102 are divided into group A arranged in area A, group B arranged in area B, and group C arranged on area C. When current is controlled for each of the groups, for example, the control of current values (A: ampere) can be conducted as shown in the following Table 1. Table 1 shows current values in the case where there are three types of the lighting modes that are preset by the user or preset at the time of product-shipment. Table 1 shows a value of current flowing in each of the groups at each of the lighting modes.

TABLE 1

| | Group A | Group B | Group C |
|---|---|---|---|
| High Brightness Mode | 1.6 A | 1.6 A | 1.6 A |
| Normal Mode | 1.5 A | 1.4 A | 1.3 A |
| Power Saving Mode | 1.0 A | 0.8 A | 0.6 A |

Alternatively, for example, an outside air temperature may be measured over the course of time, and the current control section 109 may reduce a value of current flowing in one of the groups or all the groups when the outside air temperature is high.

Since the semiconductor laser light sources 101 generates heat, the semiconductor laser light sources 101 are installed on the base plate 102 consisting of a material that has high thermal conductivity as described later, as shown in FIG. 1A and FIG. 1B. The light source device 100 is configured so as to dissipate heat that has been emitted by the semiconductor laser light sources 101.

There is no particular limitation in the number of the semiconductor laser light sources 101. For example, when the semiconductor laser light sources 101 are used as light sources in an image display apparatus such as a projector and the like, the semiconductor laser light sources 101 can be arranged in an 4 (lengthwise)×6 (widthwise) manner as shown in FIG. 1A. Luminous fluxes of light irradiated from these semiconductor laser light sources 101 are adjusted by an optical component so as to form a single spot, and then, wavelength of the irradiated light is converted by a frequency conversion material as appropriate to be used as a projection light.

<Regarding Base Plate>

Description will be provided for the base plate 102. The base plate 102 is a member for arranging the semiconductor laser light sources 101 at predetermined positions. The base plate 102 transfers heat emitted by the semiconductor laser light sources 101 via receiving surfaces 112 where the semiconductor laser light sources 101 make contact with the main body part 104, and the transferred heat is dissipated. There is no particular limitation in the material for forming the base plate 102, as long as it can efficiently dissipate heat emitted from the semiconductor laser light sources 101. In the present embodiment, the base plate 102 is formed using aluminum.

There is no particular limitation in the method for installing the semiconductor laser light sources 101 onto the base plate 102. For example, as shown in FIG. 3, a method can be used in which the receiving surface 112 are provided on the base plate 102 for the respective multiple semiconductor laser light sources 101, and the main body parts 104 of the semiconductor laser light sources 101 are caused to make contact with the respective receiving surfaces 112. In such a case, the leg parts 105 (multiple lead electrodes) of the semiconductor laser light sources 101 are caused to penetrate penetration holes 113 provided at respective centers of the receiving surfaces 112 on the base plate 102, and are electrically connected in series via an insulator (not shown) by the wiring base material 103 which is described later. The multiple semiconductor laser light sources 101 that have been divided into groups are arranged in each of the multiple areas (in FIG. 1A, an example is shown in which three areas of area A, area B, and area C are set) of the base plate 102.

<Wiring Base Material>

Description will be provided for the wiring base material 103. The wiring base material 103 is a base material for electrically wiring, in series, the multiple semiconductor laser light sources 101 in the same group. There is no particular limitation in the material for forming the wiring base material 103. For example, a flexible printed base plate may be used as the wiring base material 103. Materials known in the art may be used as materials for an insulation part (base film) and a conductive part forming the flexible printed base plate. For example, a polyimide film may be used as the insulation part, and copper may be used as the conductive part.

There is no particular limitation in the method for electrically connecting the semiconductor laser light sources 101 in series. For example, a method can be used in which the lead electrodes forming the leg parts 105 of the semiconductor laser light sources 101 are caused to penetrate penetration holes provided on the conductive parts of the wiring base material 103, and a lead electrode (anode) of one of the semiconductor laser light sources 101 and a lead electrode (cathode) of an adjacent semiconductor laser light source 101 are connected by soldering.

<Regarding Cooling Device>

Description will be provided for a cooling device (cooling unit) 114. The cooling device 114 is provided for more efficiently dissipate heat emitted by the semiconductor laser light sources 101. By having the cooling device 114, cooling efficiency of the semiconductor laser light sources 101 can be increased, and extension of lifespan can be promoted.

There is no particular limitation in the type of the cooling device 114. For example, various devices can be used, such as cooling devices having built therein at least one of a heat sink, a heat pipe, a liquid cooling module, and a Peltier device. In addition, if necessary, a cooling fan may be installed adjacent thereto. As shown in FIG. 1B, in the present embodiment, the cooling device 114 that is used includes a heat sink 114a made from copper, and a cooling fan 114b. By using the heat sink 114a, a wide area can be secured for dissipating heat, and heat emitted by the semiconductor laser light sources 101 can be dissipated efficiently. As a result, a proportion of controlling of current by the current control section 109 can be reduced, and the semiconductor laser light sources 101 can be prevented from being a high temperature more efficiently while irradiating light at a high intensity.

It should be noted that, in the present embodiment, although an example has been described in which a single piece of the cooling device 114 is provided as shown in FIG. 1B; there is no particular limitation in the number of the cooling device 114. For example, a plurality of the cooling devices 114 may be provided, and the cooling devices 114 may be arranged corresponding to each of the group. In such a case, by setting cooling capacity of the cooling device 114 for cooling down group A to be higher (e.g., increasing rotation speed of the cooling fan) than cooling capacity of the cooling devices 114 for other groups, it is possible to suppress with certainty an increase in temperature of the semiconductor laser light sources 101 arranged in each of the groups. It should be noted that the temperature control may be conducted so as to equalize the values of current applied to each of the groups, if heat generation from all the groups of the semiconductor laser light sources 101 can be sufficiently suppressed, in a case where the plurality of the cooling devices 114 are provided and adjustments in the cooling capacities of the cooling devices 114 are made among the groups of the semiconductor laser light sources 101 (in a case where the cooling capacities are set to be different from each other). Furthermore, one configuration that may be employed is to maximize the brightness by applying a highest possible current value on each of the groups, while sufficiently cooling the semiconductor laser light sources 101 in each of the group in a range that does not exceed the cooling capacity of the cooling device(s) 114, and while preventing the temperatures of the semiconductor laser light sources 101 in each of the groups from being too high (so as not to exceed a predetermined upper limit temperature).

With the present embodiment described above, it is possible to set a value of current flowing in group A, which is arranged at a position that is easy to cool by the cooling fan 114b when compared to other groups (i.e., position closest to the cooling fan), to be higher than values of current flowing in group B and group C, which are arranged at positions that are difficult to be cooled by the cooling fan 114b when compared to group A (i.e., more distantly located positions from the cooling fan than group A). On the other hand, by setting the values of current flowing in group B and group C to be lower than the value of current flowing in group A, it is possible to suppress an increase in temperature of the semiconductor laser light sources 101 belonging to group B and group C, and prolong their lifespan. As a result, it becomes possible to reduce variation of lifespan among the multiple semiconductor laser light sources 101, and extend the lifespan of the light source device 100. With this, a highly reliable light source device 100 can be provided. It should be noted that a value of current flowing in group B may be set to be higher than that for group C.

### Second Embodiment

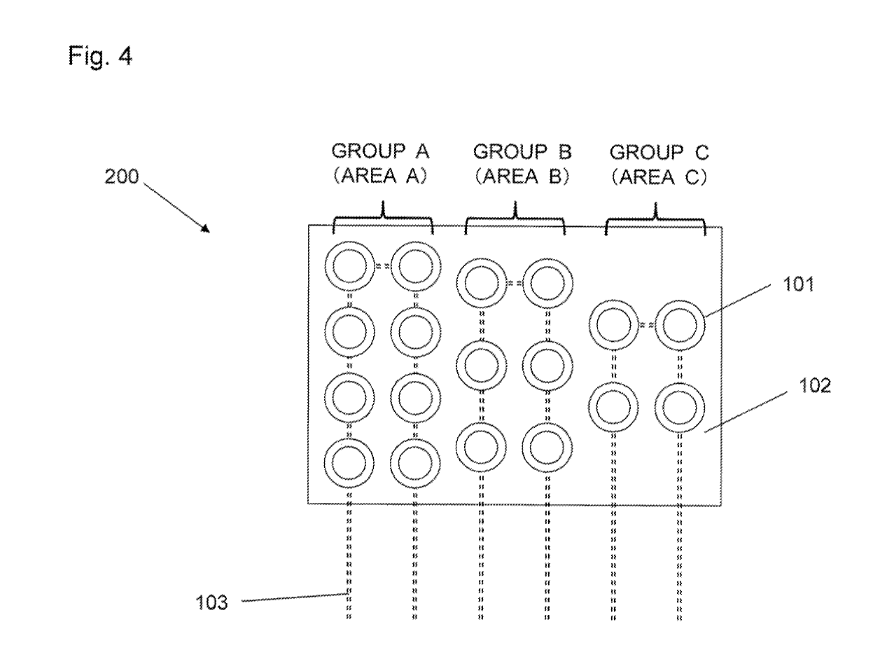

In the following, a light source device 200 according to the present embodiment will be described with reference to FIG. 4. FIG. 4 is an illustrative diagram of the light source device 200 according to the present embodiment.

As shown in FIG. 4, in the light source device 200 according to the present embodiment, the number of the semiconductor laser light sources 101 belonging to a group is eight for group A as similar to that in the first embodiment, but is six for group B, and is four for group C. Except for the above described point, the components are identical to those of the first embodiment, and reference characters identical to those in the first embodiment are provided thereto and descriptions of those are omitted. As shown in FIG. 4, the number of the semiconductor laser light sources 101 arranged per unit area is smaller for a group arranged at a leeward position that is difficult to be cooled than a group arranged at a windward position. With this, the amount of heat generated in each of the groups located at a leeward position is suppressed, and the temperatures of the semiconductor laser light sources 101 in each of the groups can be appropriately controlled. In addition, the cooling efficiency can be increased. As a result, variation of lifespan among the multiple semiconductor laser light sources 101 can be reduced, and extension of lifespan of the light source device 100 can be promoted.

In the light source device 200 according to the present embodiment, temperature is controlled by reducing the number of the semiconductor laser light sources 101 per unit area for a group located leeward. Thus, the multiple semiconductor laser light sources 101 may be connected in series for each of the groups, but it is not necessary for them to be connected in series in each of the groups.

In the present embodiment, an example has been shown in which the number of the semiconductor laser light sources 101 arranged per unit area is reduced for a group arranged at a leeward position that is difficult to be cooled, when compared to the number per unit area in the first embodiment. However, the number of the semiconductor laser light sources 101 arranged per unit area may be increased for a group arranged at a windward position that is easy to cool, when compared the number per unit area in the first embodiment. Also in this case, it is possible to reduce variation of lifespan among the multiple semiconductor laser light sources 101, sustain a high optical output from each of the semiconductor laser light sources 101, and promote the extension of lifespan of the light source device 100.

### Third Embodiment

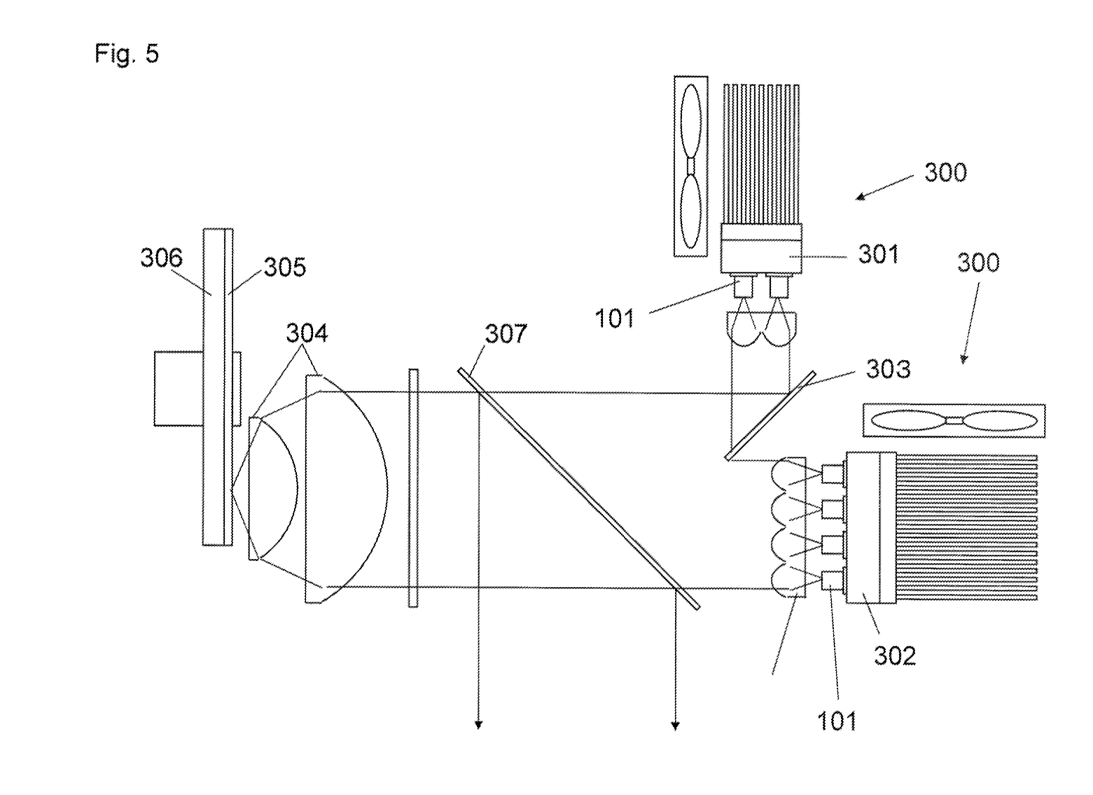

In the following, a light source device according to the present embodiment will be described with reference to FIG. 5. As shown in FIG. 5, in a light source device 300 according to the present embodiment, a light source-installed part, where the semiconductor laser light sources 101 are arranged, is formed on multiple base plates that are thermally isolated from each other (in FIG. 5, an example is shown in which two base plates of a base plate 301 and a base plate 302 are provided). In other words, the multiple base plates are separately arranged. Except for the above described point, the components are identical to those of the first embodiment, and reference characters identical to those in the first embodiment are provided thereto and descriptions of those are omitted.

In the present embodiment, multiple base plates are provided. On each of the base plates (the base plate 301 and the base plate 302), at least one group including at least one of the semiconductor laser light sources 101 exists. By having the multiple base plates 301 and 302, sizes of the base plate 301 and the base plate 302 can be reduced. In addition, the small-sized base plates 301 and 302 increase the degree of freedom in the arrangement within the light source device 300. Thus, the degree of integration of each of the component in the light source device 300 can be increased, and the size of the light source device 300 as a whole can be reduced. Furthermore, since the base plate 301 and the base plate 302 are thermal isolated from each other, a better cooling efficiency can be obtained and temperature control can be conducted easily, when compared to having all the semiconductor laser light sources 101 arranged on a single base plate 102.

In the present embodiment, on the multiple base plates (the base plate 301 and the base plate 302), the multiple semiconductor laser light sources 101 form a single group, or are divided into multiple groups and electrically connected in series. In such a case, it is preferable to arrange the multiple semiconductor laser light sources 101 such that light irradiated from each of the semiconductor laser light sources 101 are condensed at a single spot by an optical component. As shown in FIG. 5, in the present embodiment, light irradiated from the semiconductor laser light sources 101 arranged on the base plate 301 is reflected by a reflective mirror 303, and passes through a dichroic mirror 307. On the other hand, light irradiated from the semiconductor laser light sources 101 arranged on the base plate 302 passes through the dichroic mirror 307. Light irradiated from the semiconductor laser light sources 101 on the base plate 301 and the base plate 302 which are separate base plates are condensed by a condensing lens 304 into a single spot. It should be noted that the dichroic mirror 307 has a property of allowing light irradiated from the semiconductor laser light sources 101 on the base plate 301 and the semiconductor laser light sources 101 on the base plate 302 to pass through, but reflecting fluorescent light obtained through frequency conversion by a frequency conversion material which is described later. In such manner, although the semiconductor laser light sources 101 are arranged separately on the base plate 301 and the base plate 302 in the light source device 300, irradiated light from the semiconductor laser light sources 101 on the base plate 301 and irradiated light from the semiconductor laser light sources 101 on the base plate 302 are condensed to be irradiated on a single spot, and thereby a high intensity colored light can be obtained.

Wavelength of the irradiated light that has been condensed on a single spot is converted by a frequency conversion section (frequency conversion unit) 306 on which a frequency conversion material 305 is provided as shown in FIG. 5, and thereby light having various colors can be obtained. As the frequency conversion material 305, for example, fluorescent substances can be used. As the fluorescent substances, for example, red fluorescent substance capable of emitting red light, green fluorescent substance capable of emitting green light, and the like can be used. As the frequency conversion section 306, for example, a fluorescence base plate having provided thereon the frequency conversion material 305 can be used. There is no particular limitation in the method for disposing the frequency conversion material 305 on the fluorescence base plate. For example, a method can be used in which grooves are created on the surface of the fluorescence base plate, and a mixture obtained by mixing the frequency conversion material 305 and a binder consisting of an organic matter or an inorganic matter is applied on the groove.

### Fourth Embodiment

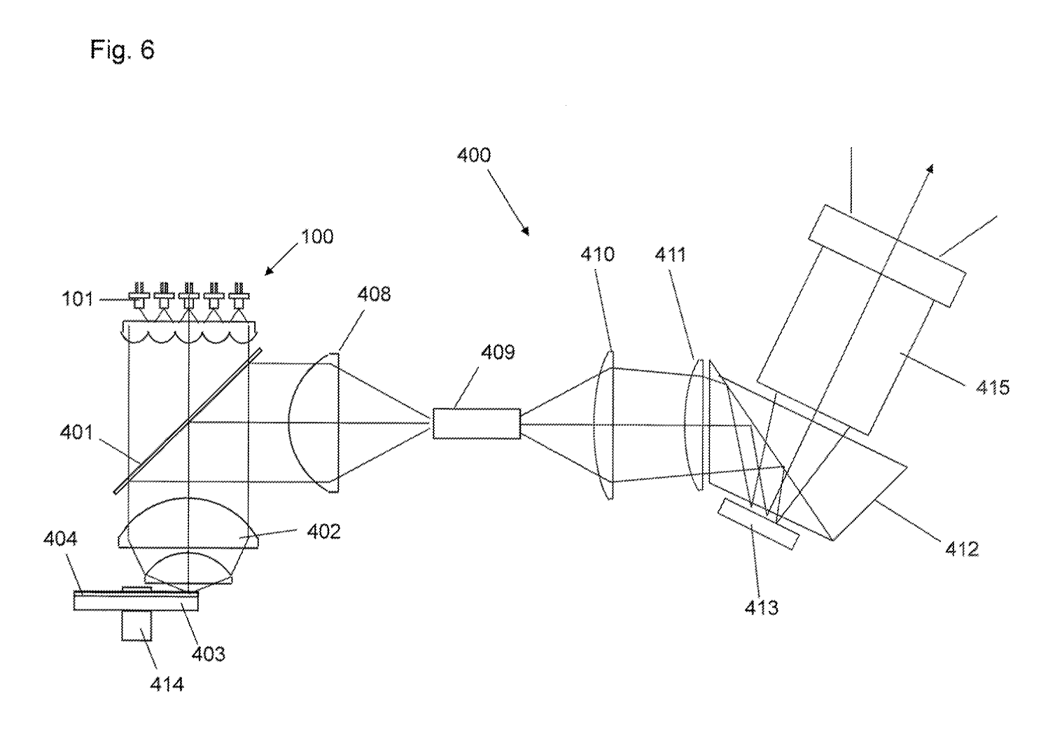

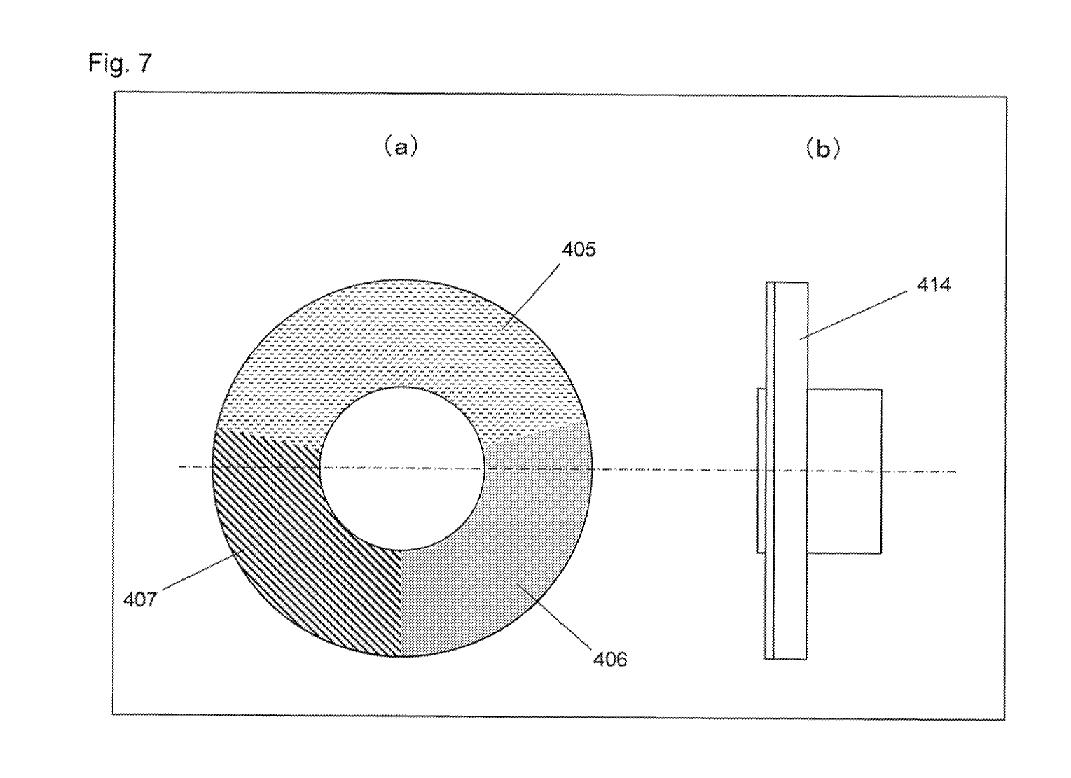

In the following, an image display apparatus 400 according to the present embodiment will be described with reference to FIG. 6. FIG. 6 is an illustrative diagram of the image display apparatus 400 according to the present embodiment, and shows an example of a configuration of a DLP (Registered Trademark) (Digital Light Processing) projector. FIG. 7 is an illustrative diagram of a frequency conversion section (frequency conversion unit) 403 according to the present embodiment; and FIG. 7 (a) is a front view of the frequency conversion section 403, and FIG. 7 (b) is a side view of the frequency conversion section 403. As shown in FIG. 6, the image display apparatus 400 according to the present embodiment is an image display apparatus that uses the light source device 100 according to the first embodiment. The image display apparatus 400 includes: the light source device 100 according to the first embodiment; a condensing lens 402 configured to condense light irradiated from the light source device 100; the frequency conversion section 403 including a frequency conversion material 404 configured to convert the wavelength of the irradiated light condensed by the condensing lens 402; a light guiding section (light guiding unit) 409 configured to guide luminous fluxes of the irradiated light whose wavelengths have been converted by the frequency conversion section 403; an image display element 413 configured to modulate the irradiated light guided by the light guiding section 409, in accordance with an image signal; and a projection lens 415 configured to project, onto a screen, the irradiated light that has been modulated by the image display element 413.

As shown in FIG. 6, the irradiated light from the semiconductor laser light sources 101 passes through a dichroic mirror 401, is condensed by the condensing lens 402, and is irradiated onto the frequency conversion material 404 provided on the surface of the frequency conversion section 403. The dichroic mirror 401 used in the present embodiment has a property of allowing light irradiated from the semiconductor laser light sources 101 to passes through, but reflecting fluorescent light obtained through frequency conversion by the frequency conversion material 404 which is described later. In the present embodiment, three types of fluorescent substances are used as the frequency conversion material 404, and are separately provided on three segment areas 405, 406, and 407 on a surface of a fluorescence base plate that functions as the frequency conversion section 403 as shown in FIG. 7 (a). In the present embodiment, a red fluorescent substance is disposed on the segment area 405, a green fluorescent substance is disposed on the segment area 406, and a blue fluorescent substance is disposed on the segment area 407. As a result, when semiconductor laser light sources 101 configured to irradiate ultraviolet light is used as the semiconductor laser light sources 101, the light irradiated on each of the segment areas 405, 406, and 407 becomes an excitation light, and the segment areas 405, 406, and 407 can respectively emit red, green, and blue fluorescent lights whose wavelengths are longer than the excitation light.

The obtain fluorescent light are reflected by the dichroic mirror 401, condensed by a condensing lens 408, and guided to the light guiding section 409 as shown in FIG. 6. In the present embodiment, a rod integrator is used as the light guiding section 409. Emitted light whose intensity of illumination have been made uniform by the light guiding section 409 enters a DMD (Digital Micromirror Device), which is the image display element 413, via a relay lens 410, a field lens 411, and a total reflection prism 412. Therefore, a relay optical system is formed such that the shape of an emission surface of the rod integrator is efficiently and uniformly transferred and condensed onto the DMD.

The DMD is formed by of two-dimensionally arranging minute mirrors. The DMD creates temporarily modulated signal lights, by changing a tilt of each of the mirrors in accordance with image input signals of red, green, and blue. When the DMD is driven by an image signal for red, for example, in the light source device 100, timing-control is conducted for moving the segment area 405 to a condensed spot of the irradiated light by a rotating mechanism (rotating unit) 414 such as an electric motor and the like, such that excitation light is irradiated exactly on the segment area 405 and that red light emitted from the red fluorescent substance is outputted. Similarly, when the DMD is driven by an image signal for green, timing-control is conducted for moving the segment area 406 to a condensed spot of the irradiated light by the rotating mechanism 414 such that the irradiated light is irradiated on the segment area 406. When the DMD is driven by an image signal for blue, timing-control is conducted for moving the segment area 407 to a condensed spot of the irradiated light by the rotating mechanism 414 such that the excitation light is irradiated on the segment area 407. The irradiated light modulated by the DMD is projected onto a screen (not shown) by the projection lens 415.

With the present embodiment described above, it is possible to reduce variation of lifespan among the multiple semiconductor laser light sources, and extend lifespan of the light source device 100. As a result, the image display apparatus 400 including the light source device 100 that is highly reliable can be provided.

### Fifth Embodiment

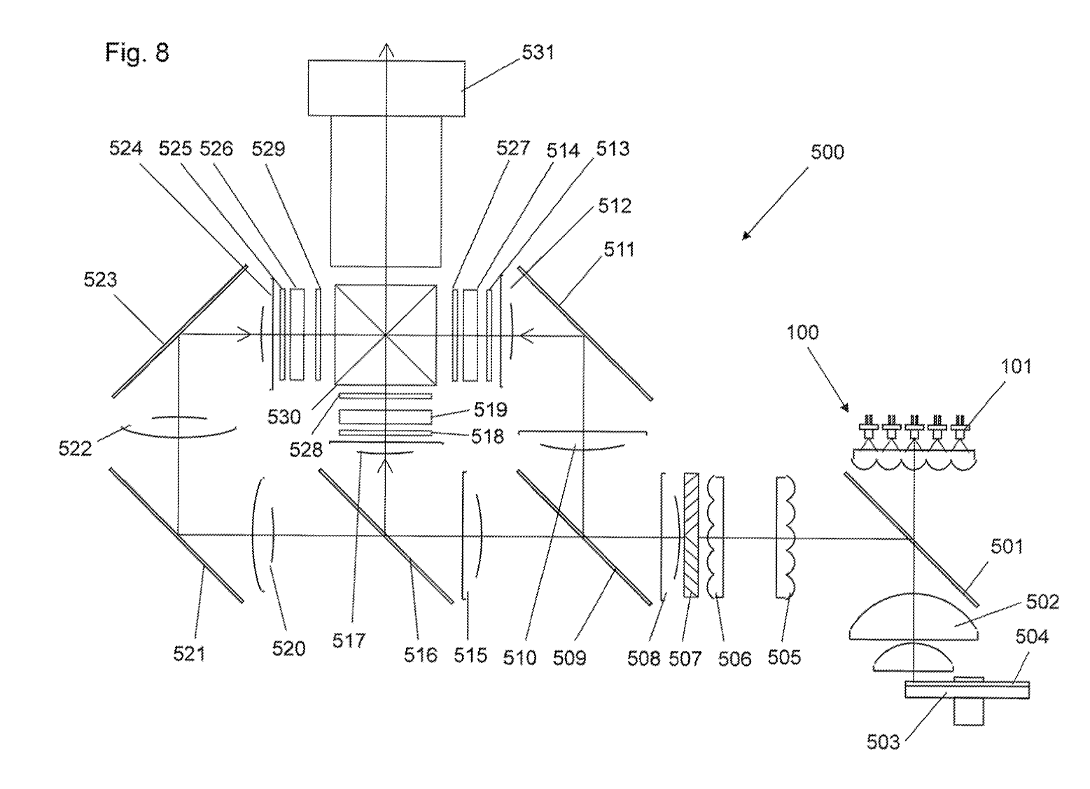

In the following, another embodiment of an image display apparatus including a light source device of the present invention will be described with reference to the drawings. FIG. 8 is an illustrative diagram of an image display apparatus 500 according to the present embodiment, and shows an example of a configuration of a liquid crystal projector. The components of the light source device are identical to those of the light source device 100 according to the first embodiment, and reference character identical to those in the first embodiment are provided thereto and descriptions of those are omitted.

In the image display apparatus 500 according to the present embodiment, as shown in FIG. 8, light irradiated from the semiconductor laser light sources 101 passes through a dichroic mirror 501, is condensed by a condensing lens 502, and irradiated on a frequency conversion material 504 provided on the surface of a frequency conversion section (frequency conversion unit) 503. The dichroic mirror 501 used in the present embodiment is identical to that used in the fourth embodiment, and detailed description thereof is omitted. The frequency conversion material 504 includes three types of fluorescent substances of red, green, and blue; and is uniformly mixed and disposed on the surface of the fluorescence base plate as the frequency conversion section 503. Fluorescent light obtained through frequency conversion by the frequency conversion material 504 is reflected by the dichroic mirror 501, passes through a first integrator lens array 505, a second integrator lens array 506, a polarization conversion element 507, and a condensing lens 508, and the wavelengths of the fluorescent light are spatially separated.

A dichroic mirror 509 has a property of reflecting blue light but allowing light ranging from green to red to passes through. Blue light reflected by the dichroic mirror 509 enters a blue liquid crystal display element 514 via a relay lens 510, a reflective mirror 511, a field lens 512, and an incident side polarizing plate 513.

Of the light that has passed through the dichroic mirror 509 and a relay lens 515, green fluorescence is reflected by a dichroic mirror 516, and enters a green liquid crystal display element 519 via a field lens 517 and an incident side polarizing plate 518.

On the other hand, red light that has passes through the dichroic mirror 516 enters a red liquid crystal display element 526 via a relay lens 520, a reflective mirror 521, a relay lens 522, a reflective mirror 523, a field lens 524, and an incident side polarizing plate 525.

Signal light modulated in accordance with inputted image signal by the liquid crystal display elements 514, 519, and 526 passes through an emission side polarizing plate 527, an emission side polarizing plate 528, and an emission side polarizing plate 529, and enters a cross dichroic prism 530. Modulated signal light having three colors of red, green, and blue are spatially multiplexed by the cross dichroic prism 530, and the multiplexed light is projected onto a screen (not shown) by a projection lens 531.

With the present embodiment described above, it is possible to reduce variation of lifespan among the multiple semiconductor laser light sources, and extend lifespan of the light source device 100. As a result, the image display apparatus 500 including the light source device 100 that is highly reliable can be provided.

It should be noted that, the light source device of the present invention can be used not only for projectors but also as light sources for various projection type display devices such as a rear projection type display device and the like.

### EXAMPLES

Next, the light source device of the present invention will be specifically described by means of Examples; however, the present invention is not limited to the Examples in any way.

### Example 1

As shown in FIG. 1A, semiconductor laser light sources were arranged on a base plate in a 4 (lengthwise)×6 (widthwise) manner. The semiconductor laser light sources were divided into group A, group B, and group C so as to each include eight of the semiconductor laser light sources, and the multiple semiconductor laser light sources in each of the groups were electrically connected in series. Current values shown in Table 2 were applied for 10,000 hours on each of the groups, and optical outputs at the beginning and optical outputs after 10,000 hours were measured. Table 2 shows heat resistances (cooling performances), applied current values (LD current values), optical outputs at the beginning, optical outputs after 10,000 hours, and sustaining rates of optical outputs after 10,000 hours for the semiconductor laser light sources belonging to each of the groups. It should be noted that, with regard to the heat resistance (cooling performance), a smaller numerical value indicates a better cooling performance.

### Comparative Example 1

In Comparative Example 1, the same current value was applied for all the groups, whereas optical outputs were calculated by a method similar to Example 1. The result is shown in Table 2.

TABLE 2

| | Example 1 | | | | | | | Comparative Example 1 | | | | | | |
|---|---|---|---|---|---|---|---|---|---|---|---|---|---|---|
| | Group A | | Group B | | Group C | | Total | Group A | | Group B | | Group C | | Total |
| Heat Resistance | 0.60° | C./W | 0.90° | C./W | 1.20° | C./W | — | 0.60° | C./W | 0.90° | C./W | 1.20° | C./W | — |
| (Cooling Performance) | | | | | | | | | | | | | | |
| LD Current Value | 1.10 | A | 0.99 | A | 0.90 | A | — | 1.00 | A | 1.00 | A | 1.00 | A | — |
| Optical Output | 10.3 | W | 9.0 | W | 7.9 | W | 27.2 W | 9.4 | W | 9.1 | W | 8.7 | W | 27.2 W |
| at the beginning | | | | | | | | | | | | | | |
| Optical Output | 5.5 | W | 4.5 | W | 3.8 | W | 13.8 W | 6.2 | W | 4.4 | W | 2.1 | W | 12.7 W |
| after 10,000 hours | | | | | | | | | | | | | | |

| | | | | | | | | |
|---|---|---|---|---|---|---|---|---|
| Sustaining Rate of | — | — | — | 50.9% | — | — | — | 46.6% |
| Optical Output after | | | | | | | | |
| 10,000 hours | | | | | | | | |

As shown in Table 2, with the light source device according to Example 1 in which the current values were controlled in each of the groups, the optical output after 10,000 hours was 50.9% of the optical output at the beginning. With the light source device according to Comparative Example 1, the same was 46.6%. From this result, after elapsing of a long period of time, it was proven that reduction in output is smaller and lifespan is longer. In addition, when optical output values of each of the groups were compared in Comparative Example 1, the optical output after 10,000 hours for the semiconductor laser light sources belonging to group C was merely 2.1 W, whereas the optical output after 10,000 hours for the semiconductor laser light sources belonging to group A was 6.2 W; and the difference between the two was significantly large. Therefore, it was revealed that variation of lifespan is large for semiconductor laser light sources arranged even on the same base plate. On the other hand, with the light source devices according to Example 1, the optical output of the semiconductor laser light sources in group C which had the most reduced optical output after 10,000 hours was 3.8 W, and the optical output of the semiconductor laser light sources in group A was 5.5 W. Thus, it was proven that the difference in optical outputs between the two was markedly smaller when compared to that of Comparative Example 1. It is possible to set a value of current flowing in group A, which is arranged at a windward position that is easy to cool by the cooling fan, to be higher than values of current flowing in group B and group C, which are arranged at leeward positions that are difficult to be cooled by the cooling fan (in particular, it is difficult to cool group C). On the other hand, by setting the values of current flowing in group B and group C to be lower than the value of current flowing in group A, it is possible to suppress temperature increases of the semiconductor laser light sources 101 belonging to group B and group C and prolong their lifespan. As a result, it becomes possible to provide the light source device 100 that is highly reliable due to having an extended lifespan caused by a reduction in variation of lifespan among the multiple semiconductor laser light sources 101.

What is claimed is:

1. A light source device comprising:
multiple semiconductor laser light sources;
a base plate having thereon an installation area on which the multiple semiconductor laser light sources are installed and which is divided into multiple areas, thus dividing the multiple semiconductor laser light sources on the installation area into multiple groups such that each of the groups includes one of the multiple semiconductor laser light sources or at least two of the semiconductor laser light sources that are electrically connected in series; and
a current control unit configured to conduct temperature control of the semiconductor laser light sources by independently controlling a value of current flowing in each of the groups of the multiple semiconductor laser light sources on the installation area.

2. The light source device according to claim 1, wherein the current control unit conducts the temperature control such that a value of current flowing in a group of semiconductor laser light sources among the multiple groups becomes smaller as temperature of the semiconductor laser light sources in the group becomes higher, in a case where conditions of the current flowing in the semiconductor laser light sources are identical among the multiple groups.

3. The light source device according to claim 1, wherein the current control unit conducts the temperature control such that a value of current flowing in a group of semiconductor laser light sources among the multiple groups becomes larger as temperature of the semiconductor laser light sources in the group becomes lower, in a case where conditions of the current flowing in the semiconductor laser light sources are identical among the multiple groups.

4. The light source device according to claim 1, further comprising a cooling unit configured to cool the multiple semiconductor laser light sources by causing fluid that absorbs heat released from the multiple semiconductor laser light sources to flow, wherein
the current control unit conducts the temperature control such that a value of current flowing in a group of semiconductor laser light sources among the multiple groups becomes larger for a group including semiconductor laser light sources that are cooled at more upstream of a circulation route of the fluid of the cooling unit.

5. The light source device according to claim 1, further comprising a current ratio calculating unit configured to calculate, as a current ratio, a ratio of a value of current flowing in one group of the semiconductor laser light sources among the multiple groups with regard to a value of current flowing in another group of the semiconductor laser light sources.

6. The light source device according to claim 1, wherein the current control unit conducts the temperature control based on a result of comparing temperatures of the semiconductor laser light sources among the multiple groups.

7. The light source device according to claim 1, wherein:
the light source device operable to select a lighting mode that is to be used from among multiple lighting modes; and
the current control unit conducts the temperature control in accordance with the selected lighting mode.

8. The light source device according to claim 1, wherein the current control unit conducts the temperature control in accordance with a lighting time period of the semiconductor laser light sources.

9. The light source device according to claim 1, comprising
a plurality of the base plates, wherein:
the plurality of the base plates are thermally isolated from each other;
the multiple semiconductor laser light sources are divided and arranged on the plurality of base plates; and
the semiconductor laser light sources arranged on each of the base plates form a single group or are divided into multiple groups.

10. The light source device according to claim 9, further comprising an optical component configured to condense light irradiated from the multiple semiconductor laser light sources, wherein
the optical component is arranged so as to condense the light irradiated from the multiple semiconductor laser light sources onto a single area.

11. The light source device according to claim 10, further comprising a frequency conversion material configured to convert wavelength of the light irradiated from the multiple semiconductor laser light sources, wherein
the frequency conversion material is disposed on the area where the light condensed by the optical component is irradiated.

12. The light source device according to claim 1, further comprising a cooling unit that is thermally connected to the base plate.

13. The light source device according to claim 1, wherein wavelengths emitted from the multiple semiconductor laser light sources are identical.

14. A light source device comprising:
multiple semiconductor laser light sources; and
a base plate having thereon an installation area on which the multiple semiconductor laser light sources are installed and which is divided into multiple areas, thus dividing the multiple semiconductor laser light sources on the installation area into multiple groups, wherein
temperature control of the semiconductor laser light sources is conducted by providing, on the base plate, areas in which installation densities of the semiconductor laser light sources are different from each other.

15. An image display apparatus comprising:
the light source device according to claim 1;
a condensing lens configured to condense light irradiated from the light source device;
a frequency conversion unit including a frequency conversion material configured to convert wavelength of the irradiated light condensed by the condensing lens;
a light guiding unit configured to guide luminous fluxes of the irradiated light whose wavelength is converted by the frequency conversion unit;
an image display element configured to modulate the irradiated light guided by the light guiding unit, in accordance with an image signal; and
a projection lens configured to project, onto a screen, the irradiated light modulated by the image display element.

16. An image display apparatus comprising:
the light source device according to claim 14;
a condensing lens configured to condense light irradiated from the light source device;
a frequency conversion unit including a frequency conversion material configured to convert wavelength of the irradiated light condensed by the condensing lens;
a light guiding unit configured to guide luminous fluxes of the irradiated light whose wavelength is converted by the frequency conversion unit;
an image display element configured to modulate the irradiated light guided by the light guiding unit, in accordance with an image signal; and
a projection lens configured to project, onto a screen, the irradiated light modulated by the image display element.
